(19) United States
(12) Patent Application Publication
(10) Pub. No.: US 2015/0009082 A1
(43) Pub. Date: Jan. 8, 2015

(54) SLOT ANTENNA

(71) Applicant: Toru Taura, Tokyo (JP)

(72) Inventor: Toru Taura, Tokyo (JP)

(73) Assignee: NEC CORPORATION, Tokyo (JP)

(21) Appl. No.: 14/371,231

(22) PCT Filed: Feb. 4, 2013
(86) PCT No.: PCT/JP2013/000605

§ 371 Date: Jul. 9, 2014

(30) Foreign Application Priority Data
Feb. 7, 2012 (JP) 2012-024278

(51) Int. Cl. H01Q 13/10

(52) U.S. Cl. CPC H01Q 13/106
USPC 343/767

(57) ABSTRACT

This slot antenna is provided with: a dielectric substrate (1); a dielectric surface (10) formed on one surface of the dielectric substrate (1); a slot (11) formed in the dielectric surface (10) and having an open end at one end; and a first stub (21) and a second stub (22) which are L-shaped conductors formed in the slot (11) interior and which are individually connected at one end to the dielectric surface (10). In the slot (11) interior, a first side (11a) at which a connecting part (21a) for the first stub (21) and the dielectric surface (10) is formed, and a second side (11b) at which a connecting part (22a) for the second stub (22) and the dielectric surface (10) is formed, are opposed to one another. or claim 2,

### TECHNICAL FIELD

The invention relates to a slot antenna, particularly a slot antenna which adjusts a resonance frequency by using a stub.

### BACKGROUND ART

A quarter of wavelength corresponding to a usage frequency is generally required as a length of a slot antenna formed on a dielectric substrate. For example, the slot antenna has a length of about 90 mm at 800 MHz. Therefore, such slot antenna is too large to apply to a mobile wireless terminal having mounting space constraints.

Patent document 1 discloses a method for forming a condenser at a slot end, as a technique miniaturizing an antenna. In a configuration disclosed in Patent document 1 in which the condenser is formed at the slot end, a resonant frequency of the antenna can be largely shifted with small capacity. For example, Patent document 1 discloses the configuration in which the condenser is formed at the slot end using a convex part of a conductor. Patent document 1 further discloses a configuration in which the condenser is formed at the slot end by mounting a chip condenser at the slot end.

Patent document 2 discloses a configuration in which a radial conductor is further added to a part of a radial conductor configuring a slot in a slot interior.

### PRIOR ART DOCUMENT

### Patent Document

[Patent Document 1]

Japanese Patent Application Laid-Open No. Hei 5-110332 A

[Patent Document 2]

Japanese Patent Application Laid-Open No. 2004-48119 A

### DISCLOSURE OF THE INVENTION

### Problem to be Solved by the Invention

In the configuration disclosed in Patent Document 1 in which the condenser is formed at the slot end, the resonance frequency of the antenna largely changes due to a small error of a loaded capacitance value. It is therefore necessary to form the loaded capacitance value with a high degree of accuracy. Specifically, in the configuration in which the condenser is formed using the convex part of the conductor, the resonance frequency of the antenna largely changes due to a variation in thickness of a dielectric substrate which occurs at the time of massive production and due to a variation in specific permittivity. In the configuration with the chip condenser, the resonance frequency of the antenna shifts due to a variation in capacitance values of the chip condenser itself.

In the slot antenna disclosed in Patent Document 2, a detailed shape, a size, a positional relation, and the like, of the radial conductor added to the slot interior are not clearly described. It is therefore not clear whether or not the radial conductor added to the slot interior contributes to addition of a capacitance required for miniaturizing the antenna.

An object of the invention is to solve the aforementioned problems and provide a small slot antenna in which an antenna resonance frequency does not largely change at the time of massive production.

### Means For Solving the Problem

The slot antenna of the invention includes a dielectric substrate, a conductor surface formed on one surface of the dielectric substrate, a slot formed in the conductor surface and having an open end at one end, and a first stub and a second stub which are L-shaped conductors formed in the slot interior and which are connected at each end to the conductor surface. In the slot antenna, in the slot interior, a first side at which a connecting part for the first stub and the conductor surface is formed, and a second side at which a connecting part for the second stub and the conductor surface is formed are opposed to one another.

### Effect of the Invention

According to the invention, the slot antenna can be provided in which, when the slot antenna is miniaturized, particularly when the slot antenna is miniaturized by adding a capacitance, a variation in the resonance frequencies is small.

### BRIEF EXPLANATION ON DRAWINGS

FIG. 1 a front view illustrating a configuration of a slot antenna in a first exemplary embodiment,

FIG. 2 a cross-sectional view illustrating the configuration of the slot antenna in the first exemplary embodiment,

FIG. 3 a diagram illustrating a calculation result of an antenna impedance characteristic in the first exemplary embodiment,

FIG. 4 a front view illustrating a configuration of a slot antenna in a second exemplary embodiment,

FIG. 5 a cross-sectional view illustrating the configuration of the slot antenna in the second exemplary embodiment,

FIG. 6 a diagram illustrating a calculation result of an antenna impedance characteristic in the second exemplary embodiment,

FIG. 7 a front view illustrating a configuration of a slot antenna in a third exemplary embodiment,

FIG. 8 a cross-sectional view illustrating the configuration of the slot antenna in the third exemplary embodiment,

### MODE FOR CARRYING OUT THE INVENTION

Preferable exemplary embodiments for carrying out the invention are explained below by using drawings. Though the exemplary embodiments described below include technically preferable restrictions, a scope of the invention is not limited to such restrictions.

### First Exemplary Embodiment

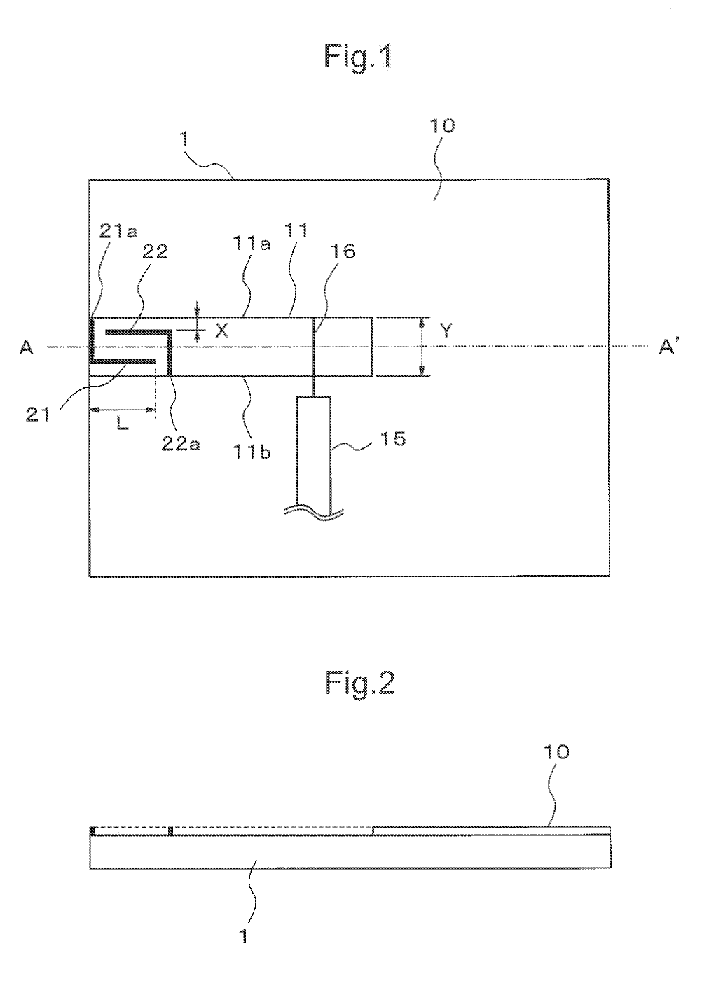

An exemplary embodiment is described in detail by referring to drawings. FIG. 1 is a front view illustrating a configuration of a slot antenna in a first exemplary embodiment. FIG. 2 illustrates a configuration of a slot antenna in the first exemplary embodiment, and is a cross-sectional view of FIG. 1 along the line A-A′. The slot antenna of the first exemplary embodiment includes a dielectric substrate 1, a conductor surface 10, a slot 11, a stub 21 (first stub), and a stub 22 (second stub).

The dielectric substrate 1 is a plate-like substrate made of a dielectric material. The conductor surface 10 is formed on one surface (e.g. an upper side of the surface) of the dielectric substrate 1. The slot 11 is formed by making a cut into the conductor surface 10, and one end of the cut forms an open end at an edge part of the conductor surface 10. The slot 11 is therefore U-shaped.

In FIG. 1, a feeding part 16 which is an external conductor and an interior conductor of a feeder line 15 is connected to the conductor surface 10 located at both sides of the slot 11 over the slot 11. A radio circuit (not shown) powers the slot 11 through the feeder line 15 and the feeding part 16.

The stub 21 and the stub 22 are composed of long and narrow L-shaped conductors formed inside the slot 11. In each of the stub 21 and the stub 22, one end connects to the conductor surface 10 and the other end is an open end to form an open-ended stub. A connecting part 21a for the stub 21 and the conductor surface 10 is formed at a first side 11a in a slot 11 interior. On the other hand, a connecting part 22a for the second stub 21 and the conductor surface 10 is formed at a second side 11b in the slot 11 interior.

As shown in FIG. 1, the first side 11a and the second side 11b are opposed to one another inside the slot 11. In the slot 11 interior, the first side 11a at which the connecting part 21a for the stub 21 and the conductor surface 10 is formed and the second side 11b at which the connecting part 22a for the stub 22 and the conductor surface 10 is formed are opposed to one another.

In the stub 21 and the stub 22, when a wavelength corresponding to a usage frequency is λ, a stub length L (distance from a point at which the stub is formed into an L-shape to the open end) satisfies L<λ/4. A width of each stub is sufficiently narrow compared with the stub length.

The stub 21 is formed so that a distance X between a tip part of the L-shaped conductor and the second side 11b forming the slot 11 is sufficiently shorter than a width Y of the slot 11, at least shorter than one-half thereof. The stub 22 is also formed so that a distance X between a tip part of the L-shaped conductor and the first side 11a forming the slot 11 is sufficiently shorter than the width Y of the slot 11, at least shorter than one-half thereof.

In the first exemplary embodiment shown in FIG. 1, the stub 21 or the stub 22 which is arranged in the slot 11 interior (open end side) forms a transmission line in which a conductor connecting to the stub 21 or the stub 22 and opposing to the slot 11 is a return path.

In such configuration, if the stub length L is formed to be L<λ/4 (λ is a wavelength corresponding to a usage frequency), the stub shows a capacitive property. When the capacitive stub is arranged in the slot interior, a resonance frequency of the slot antenna shifts toward low frequencies compared with a configuration without the stub.

In the first exemplary embodiment, the two stubs having the capacitive property are arranged so that tips (open ends) of the stubs are overlapped in the direction where the tips are opposed to one another. The stub 21 and the stub 22 are arranged point-symmetrically and have point symmetrical shape. Since the stubs are arranged in the narrow slot 11 interior, the number of stubs which can be arranged therein is limited. If the stub configuration of the invention is used, compared with an arrangement space required for one stub, the stubs 21 and 22 can be arranged almost without increasing the arrangement space. Since capacitance loaded in the slot 11 increases as the number of stubs arranged in the slot 11 increases, an amount of shift toward low frequencies of the antenna resonance frequency increases without increasing an antenna size. That is, the antenna can be miniaturized.

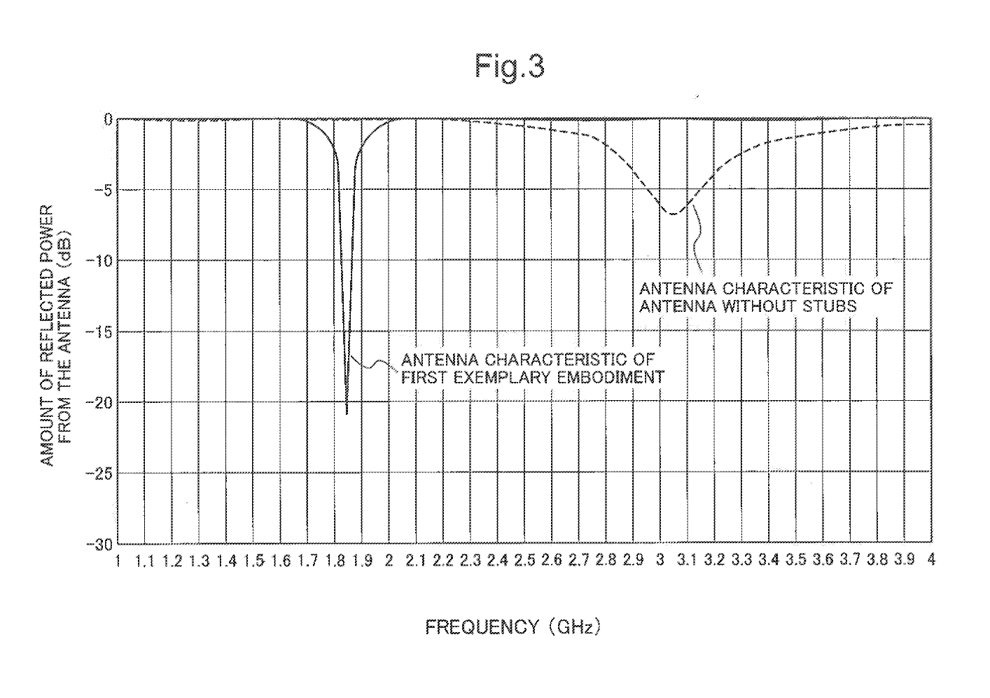

Since conductor patterns forming the stubs 21 and 22 can be formed by using a normal printed circuit board manufacturing process, variations in the lengths of the stubs 21 and 22 can be suppressed to be very small. That is, a variation in capacitance formed by the stubs 21 and 22 can be reduced and the antenna resonance frequency can be controlled with a high degree of accuracy. FIG. 3 contrastively shows a calculation result of an antenna impedance characteristic in the first exemplary embodiment and a calculation result of an antenna impedance characteristic of a slot antenna without only the stubs of the first exemplary embodiment. In FIG. 3, a horizontal axis shows a frequency and a vertical axis shows an amount of reflected power from the antenna at an antenna feeding point.

In a frequency band in which a matching condition between characteristic impedance on the antenna side of the antenna feeding point and characteristic impedance on the feeding line side thereof is improved, the amount of reflected power from the antenna at the antenna feeding point decreases and power which is fed to the antenna increases. If a frequency at which the amount of reflected power from the antenna is minimized is a resonance frequency of the antenna, as shown in FIG. 3, when the antenna impedance characteristic of the antenna without stubs shown by a dotted line is compared with the antenna impedance characteristic of the first exemplary embodiment shown by a solid line, resonance of the antenna exists in a lower frequency band in the first exemplary embodiment. The antenna characteristic of the antenna without stubs has a resonance frequency of around 3.05 GHz and the antenna characteristic of the antenna of the first exemplary embodiment has a resonance frequency of around 1.85 GHz. From the result, it is understood that if the stubs are formed in the slot as described in the first exemplary embodiment, it is possible to shift the resonance frequency of the antenna toward a low frequencies side.

As described above, the slot antenna of the first exemplary embodiment of the invention includes the stub 21 and the stub 22 which are composed of long and narrow L-shaped conductors formed inside the slot 11 whose one end forms an open end, and includes the configuration in which capacitance loaded in the slot antenna is controlled. Since the stub 21 and the stub 22 can be formed on a dielectric substrate through the normal printed circuit board manufacturing process, just like an etching method, variations in the stub lengths can be made small. Thereby, the resonance frequency of the slot antenna can be controlled with a high degree of accuracy.

### Second Exemplary Embodiment

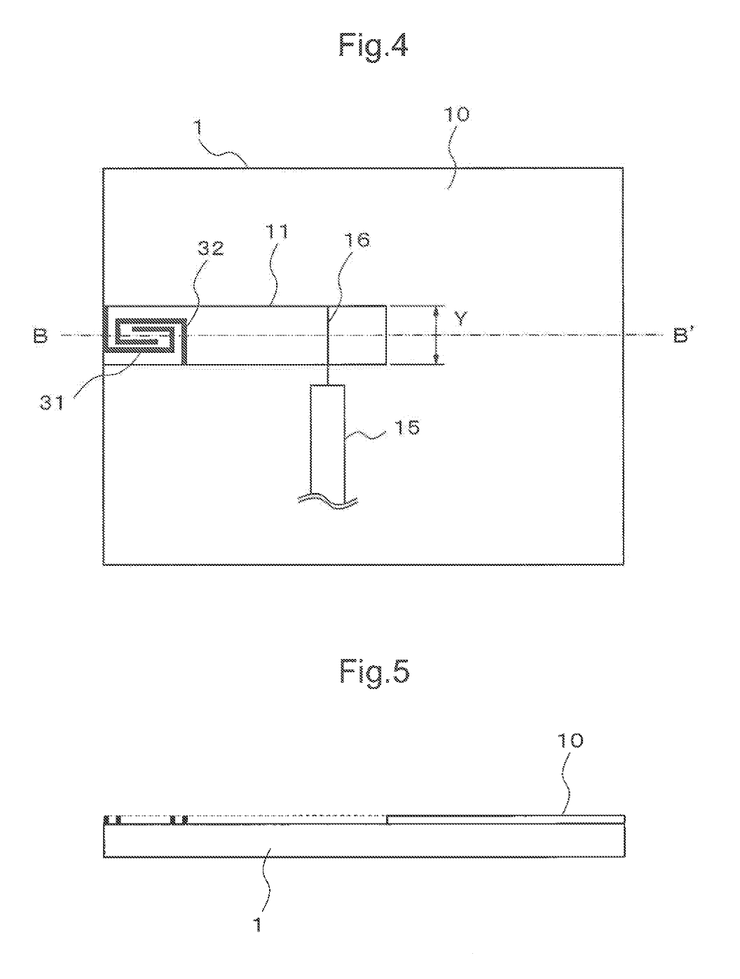

A second exemplary embodiment is explained by referring to drawings. FIG. 4 is a front view illustrating a configuration of a slot antenna in a second exemplary embodiment. FIG. 5 illustrates the configuration of the slot antenna in the second exemplary embodiment, and is a cross-sectional view along the line B-B′ in FIG. 4. The slot antenna of the second exemplary embodiment includes the dielectric substrate 1, the conductor surface 10, the slot 11, a stub 31 (first stub), and a stub 32 (second stub).

The second exemplary embodiment includes the same configuration as the first exemplary embodiment except that a shape of a stub arranged in the slot 11 is a spiral shape. The same elements as the first exemplary embodiment has the same reference numerals and explanations on the elements are omitted.

In the second exemplary embodiment shown in FIG. 4, each of the stubs 31 and 32 arranged in the slot 11 includes a shape in which a tip part of a L-shaped conductor is further elongated and bended to form a spiral shape. The stubs 31 and 32 are arranged so that tips of the stubs are overlapped in the direction where the tips are opposed to one another, just like the first exemplary embodiment, and form a shape with point symmetry. Consequently, the stubs 31 and 32 are arranged so that respective open ends of the stubs which are spirally-bended interdigitate into a gap therebetween. In such configuration, since a tip part length of the spiral part of the conductor increases, the stub length can be further elongated compared with the first exemplary embodiment. The open-ended stub shows a capacitive property if the stub length L falls within the range of L<λ/4 (λ is a wavelength corresponding to a usage frequency), and a capacitance value thereof increases as the stub length increases.

In the second exemplary embodiment, the two stubs 21 and 22 of the first exemplary embodiment are replaced by the spiral-shaped stubs 31 and 32. When the stubs 31 and 32 are arranged to overlap one another and the stub length L increases within the range of L<λ/4 (λ is a wavelength corresponding to a usage frequency), a value of capacitance loaded to the slot 11 is increased and the antenna is miniaturized.

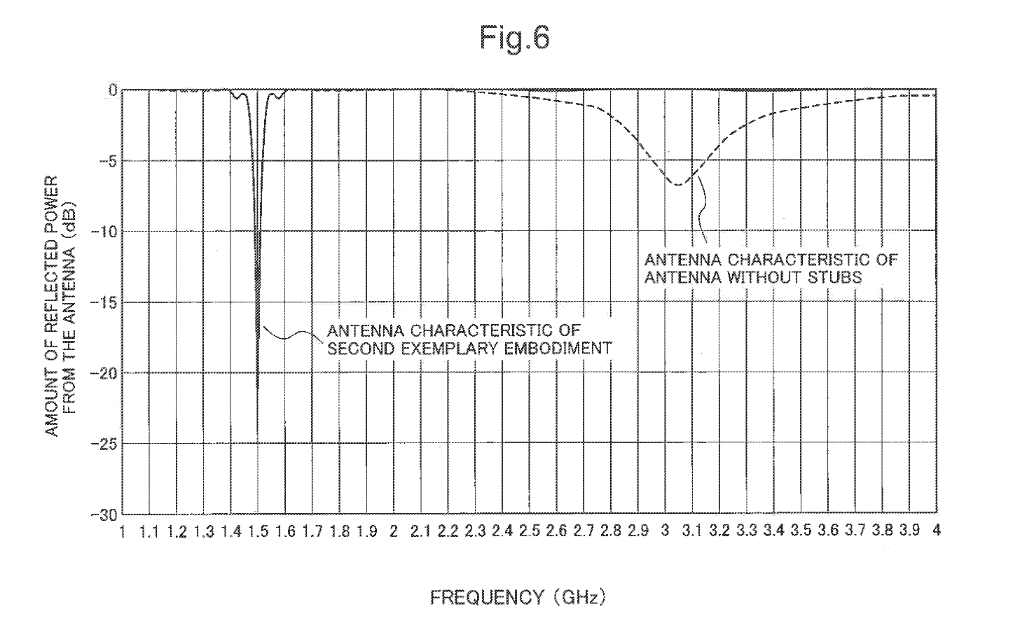

FIG. 6 contrastively shows a calculation result of an antenna impedance characteristic in the second exemplary embodiment and a calculation result of an antenna impedance characteristic of a slot antenna without only the stubs of the second exemplary embodiment. In FIG. 6, a horizontal axis shows a frequency and a vertical axis shows an amount of reflected power from an antenna at an antenna feeding point. As shown in FIG. 6, when the antenna impedance characteristic of the antenna without stubs shown by a dotted line is compared with the antenna impedance characteristic of the second exemplary embodiment shown by a solid line, resonance of the antenna exists in a lower frequency band in the second exemplary embodiment. The resonance exists at around 3.05 GHz in the antenna characteristic of the antenna without the stubs, and the resonance exists at around 1.5 GHz in the antenna characteristic of the second exemplary embodiment. From the result, it is understood that if the stubs are loaded just like the second exemplary embodiment, it is possible to shift the resonance frequency of the antenna toward a low frequencies side.

It is understood that the antenna resonance frequency of the second exemplary embodiment is lower than the antenna resonance frequency of the first exemplary embodiment shown in FIG. 3. That is because as the stub length of the stub arranged in the slot increases, capacitance loaded in the slot increases. A shift amount of the antenna resonance frequency toward a low frequencies side can be therefore increased without increasing an antenna size. The antenna can be further miniaturized compared with the first exemplary embodiment. Since the stub 21 and the stub 22 can be formed on a dielectric substrate through a normal printed circuit board manufacturing process, just like an etching method, a variation in the stub lengths can be made small. Thereby the resonance frequency of the slot antenna can be controlled with a high degree of accuracy.

### Third Exemplary Embodiment

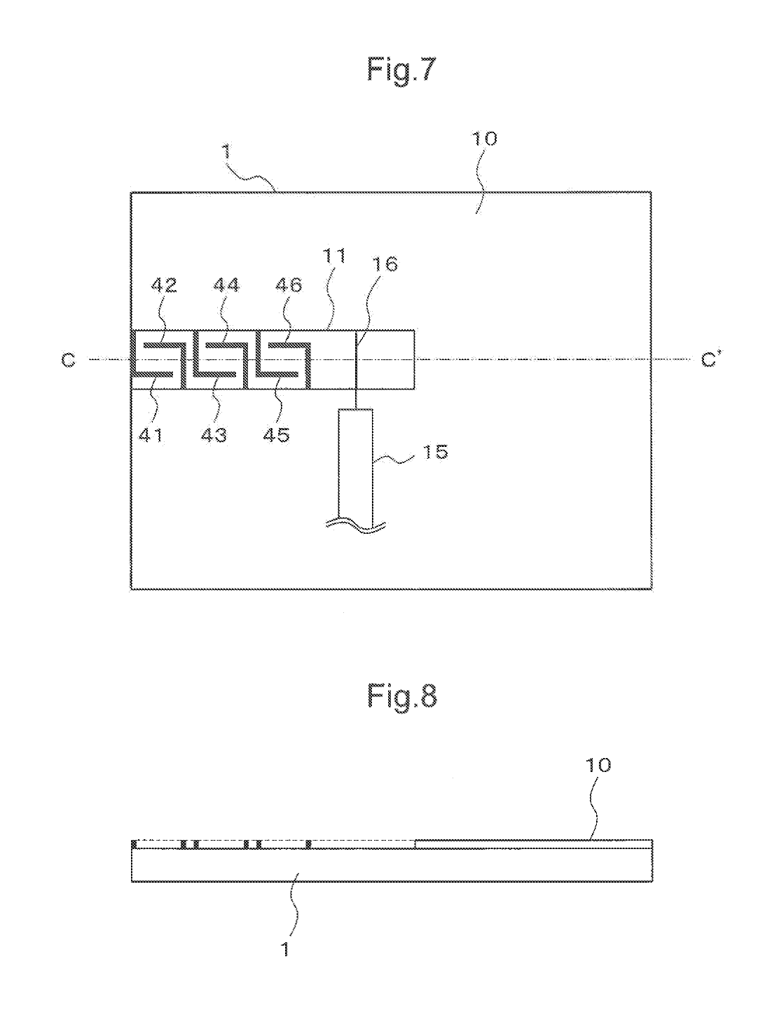

A third exemplary embodiment is explained by referring to drawings in detail. FIG. 7 is a front view illustrating a configuration of a slot antenna in a third exemplary embodiment. FIG. 8 illustrates the configuration of the slot antenna in the third exemplary embodiment, and is a cross-sectional view along the line C-C′ in FIG. 7. The slot antenna of the third exemplary embodiment includes the dielectric substrate 1, the conductor surface 10, the slot 11, stubs 41, 43, 45 (first stubs), and stubs 42, 44, 46 (second stubs).

In the slot antenna of the third exemplary embodiment, when the stub 21 and the stub 22 exemplified in the first exemplary embodiment form a pair, a plurality of the pairs are arranged in the slot 11 interior. Three pairs having a pair of the stubs 41 and 42, a pair of the stubs 43 and 44, and a pair of the stubs 45 and 46 are arranged therein. The exemplary embodiment includes the same configuration as the first exemplary embodiment except that a plurality of the pairs of the first and the second stubs are arranged in the slot 11. Therefore, the elements which are the same as the first exemplary embodiment have the same reference numerals, and explanations on the elements are omitted.

In the slot antenna of the third exemplary embodiment, since the stub 21 and the stub 22 of the first exemplary embodiment form a pair and a plurality of the pairs are arranged in the slot 11, capacitance loaded to the slot 11 further increases. A shift amount of the antenna resonance frequency toward a low frequencies side can be therefore increased without increasing the antenna size. The antenna can be further miniaturized compared with the first exemplary embodiment.

In the exemplary embodiment shown in FIG. 7, each stub is L-shaped. However, if the length L of the stub falls within the range of L<λ/4 (λ is a wavelength corresponding to a usage frequency), the shape is not limited to the L-shape and various shapes are applicable. For example, a spiral-shape shown in the second exemplary embodiment, a meander type, a folding type, and a randomly winding type are applicable. Though three pairs of stubs are exemplified in the exemplary embodiment shown in FIG. 7, the number of the pairs is not limited to three.

As described above, according to the exemplary embodiments of the invention, the stub is employed and a capacitance value loaded to the slot antenna is controlled on the basis of the stub length. Thereby, since the size of the slot antenna can be reduced and influence on the antenna resonance frequency due to a variation in thickness of the dielectric substrate or a variation in specific permittivity can be reduced, a variation in the antenna resonance frequencies which occurs at the time of massive production is suppressed and the antenna with a high degree of accuracy can be configured, even though the antenna is formed on the dielectric substrate through a normal printed circuit board manufacturing process, just like an etching method. In particular, since the slot antenna of the invention does not use a via and can be configured on a two-dimensional surface having only a conductor pattern, it becomes possible to employ a printing process using ink or conductive paste in addition to the normal printed circuit board manufacturing process, and possible to reduce manufacturing cost of the antenna.

The invention of the present application is not limited to the above mentioned embodiments. It is to be understood that to the configurations and details of the invention of the present application, various changes can be made within the scope of the invention of the present application.

This application claims priority from Japanese Patent Application No. 2012-024278 filed on Feb. 7, 2012, and the contents of which are incorporation herein by reference in their entirety.

### INDUSTRIAL AVAILABILITY

The present invention is applicable to a slot antenna controlling a resonance frequency by using a stub.

### EXPLANATION ON REFERENCE NUMERALS

1 dielectric substrate
10 conductor surface
11 slot
11a first side
11b second side
15 feeder line
16 feeding part
21 stub (first)
21a connecting part
22 stub (second)
22a connecting part
31 stub (first)
32 stub (second)
41 stub (first)
42 stub (second)
43 stub (first)
44 stub (second)
45 stub (first)
46 stub (second)

1. A slot antenna, comprising:
a dielectric substrate;
a conductor surface formed on one surface of the dielectric substrate;
a slot formed in the conductor surface and having an open end at one end; and
a first stub and a second stub which are L-shaped conductors formed in the slot interior and which are connected at each end to the conductor surface,
wherein, in the slot interior, a first side having a connection part for the first stub and the conductor surface, and a second side having a connection part for the second stub and the conductor surface are opposed to one another.

2. The slot antenna of claim 1, wherein the first stub and the second stub are arranged so that tips of the stubs are overlapped in the direction where the tips are opposed to one another.

3. The slot antenna of claim 1, wherein the first stub and the second stub each having a spiral shape are arranged to interdigitate with each other.

4. The slot antenna of claim 1, wherein the first stub and the second stub are configured as a pair and a plurality of the pairs are arranged in the slot interior.

5. The slot antenna of claim 1, wherein a distance between the part which is the open end side from the L-shaped bent point of the first stub and the second side of the slot is shorter than one-half of a width of the slot, and a distance between the part which is the open end side from the L-shaped bent point of the second stub and the first side of the slot is shorter than one-half of the width of the slot.

6. The slot antenna of claim 1, wherein each of lengths of the first stub and the second stub is shorter than a quarter of a wavelength corresponding to a usage frequency.

7. The slot antenna of claim 1, wherein the first stub and the second stub are arranged near the open end of the slot.

8. The slot antenna of claim 1, wherein the first stub and the second stub are formed on the dielectric substrate through a printed circuit board manufacturing process.

9. The slot antenna of claim 2, wherein the first stub and the second stub are configured as a pair and a plurality of the pairs are arranged in the slot interior.

10. The slot antenna of claim 3, wherein the first stub and the second stub are configured as a pair and a plurality of the pairs are arranged in the slot interior.
